(19) United States
(12) Patent Application Publication
(10) Pub. No.: US 2014/0068752 A1
(43) Pub. Date: Mar. 6, 2014

(54) ELECTRONIC DEVICE FOR RELEASING LOCK FUNCTION USING A PLURALITY OF OBJECTS AND METHOD THEREOF

(71) Applicant: Samsung Electronics Co., Ltd., Gyeonggi-do (KR)

(72) Inventor: Yeon-Kyu CHOI, Gyeongsangbuk-do (KR)

(73) Assignee: Samsung Electronics Co., Ltd., Gyeonggi-do (KR)

(21) Appl. No.: 14/012,090

(22) Filed: Aug. 28, 2013

(30) Foreign Application Priority Data
Aug. 28, 2012 (KR) 10-2012-0094267

(51) Int. Cl. G06F 21/00

(52) U.S. Cl. CPC G06F 21/00
USPC 726/16

(57) ABSTRACT

An apparatus and method for sensing an input for releasing a predetermined lock function of an electronic device is provided. The method includes setting at least two or more objects for releasing the lock function, outputting an object group including the set objects and an object group including certain objects on a lock screen, allowing a user to select at least two or more objects in the output object groups, and releasing the lock function when the selected objects are identical to previously defined objects.

### CLAIM OF PRIORITY

This application claims the benefit under 35 U.S.C. §119(a) from a Korean patent application filed in the Korean Intellectual Property Office on Aug. 28, 2012 and assigned Serial No. 10-2012-0094267, the entire disclosure of which is hereby incorporated by reference in its entirety.

### BACKGROUND

1. Field of the Invention

The present disclosure relates to an apparatus and method for sensing input of a user and releasing a predetermined lock function.

2. Description of the Related Art

Electronic devices, which have become necessities of modern people due to ease of portability, have developed into multimedia devices capable of providing various multimedia services such as a voice and video communication service, an information input and output service, and a data storage service.

As described above, the amount of information processed and displayed according to the provision of the multimedia services is being increased in electronic devices. Accordingly, there is a growing interest in an electronic device which has a touch screen capable of improving space utilization and increasing a size of a display unit thereof.

The touch screen is both an input and display device for inputting and displaying information on one screen. Accordingly, when the touch screen is installed in the electronic device, by the removal of a separate input device such as a keypad, the electronic device may increase a display size. For example, a touch screen with a full touch type in which the entire screen is applied to the touch screen is installed in the electronic device and the electronic device may enlarge a screen size by using the entire surface as a screen.

In addition, a user of the electronic device having the touch screen may write text and may draw lines using input tools such as a stylus pen and an electronic pen.

Accordingly, in general, the electronic device with the touch screen implements a touch lock function to prevent a touch error operation and enhance security for access to the electronic device via the touch screen.

The user of the electronic device typically sets a lock function with a password or pattern matching in the electronic device to strengthen security. However, for the reason that the lock function is set with the password in the electronic device, compared with when the lock function is released with the pattern matching, the password entry has a problem in that a lock function release speed is much slower than the pattern matching. When the lock function is set with the pattern matching, there is a problem in that security is lowered. For example, because those around the user can observe a user unlocking their electronic device with the pattern matching, and then become accustomed to a pattern easily, a user's privacy can be easily invaded. One of reasons why this problem occurs is because paths of touch points are easily exposed to others due to a pattern matching method of releasing a lock function by moving the paths of points output in a touch lock state.

Of course, if the user sets a difficult pattern or password to enhance security, the security is enhanced. However, the difficult pattern or password results in an inconvenience to the user when he or her uses the electronic device. On the other hand, if the user sets an easy pattern or password, it results in a convenience to him or her but can be easily observed. However, there is a problem in that security of the electronic device is lowered.

More particularly, in recently days, as the storage capacity of electronic devices have increased, it is now possible to use a service or services which can be provided using personal information, and such personal information, which must be protected, is stored in the storage space of the electronic device. However, when the security of the lock function is lowered, hacking of personal information may be increased.

Therefore, there is an urgent need in the art to provide an unlocking method for an electronic device that quickly releases lock setting of the electronic device and thus improves security.

### SUMMARY

An aspect of the present invention is to address at least some of the above-mentioned problems and/or disadvantages and to provide at least the advantages described herein below. Accordingly, an aspect of the present invention provides an apparatus and method for improving a speed for unlocking an electronic device and simultaneously strengthening a user's security.

Another aspect of the present invention provides an apparatus and method for preventing a pattern from being easily exposed to view by selecting at least two or more objects and releasing a lock function in an electronic device.

Still another aspect of the present invention provides an apparatus and method for preventing a pattern from being easily exposed to view by applying a concealment effect to at least one object in an electronic device.

Another aspect of the present invention provides an apparatus and method for extracting an object used to release a lock function from a predetermined lock screen.

In accordance with an exemplary aspect of the present invention, a method of releasing a lock function (lock state) using a plurality of objects in an electronic device can include setting at least two or more objects for releasing the lock function; outputting an object group including the set objects and an object group including certain objects on a lock screen; allowing a user to select at least two or more objects in the output object groups; and releasing the lock function when the selected objects are identical to previously defined objects.

In accordance with another exemplary aspect of the present invention, an apparatus for releasing a lock function using a plurality of objects in an electronic device is provided. The apparatus includes at least one or more processors, a memory, and at least one program comprising machine executable code which is stored in the memory and is configured to be executable by at least the one processor, wherein the program includes an instruction for setting at least two or more objects for releasing the lock function, outputting an object group including the set objects and an object group including certain objects on a lock screen, allowing a user to select at least two or more objects in the output object groups, and releasing the lock function when the selected objects are identical to previously-defined objects.

In accordance with another exemplary aspect of the present invention, a computer readable medium which stores one or more programs comprising machine executable code including instructions for allowing an electronic device to set at least two or more objects for releasing the lock function, output an object group including the set objects and an object group including certain objects on a lock screen, allow a user to select at least two or more objects in the output object groups, and release the lock function when the selected objects are identical to previously defined objects.

In another exemplary aspect of the present invention, a method of releasing a lock function using a plurality of objects in an electronic device comprises: identifying by a processor during a setting of the lock function at least two or more selected objects from the plurality of objects that are set for releasing the lock function; outputting when the lock function is engaged on the electronic device an object group including the at least two or more selected objects set for releasing the lock function and an object group including additional certain objects from the output objects groups accessible for selection; determining by the processor that at least two or more objects from the output object groups accessible for selection have been selected for releasing the lock function; and releasing the lock function when the processor determines the selected objects for releasing the lock function are identical to the two or more objects that were selected during the setting of the lock function.

### BRIEF DESCRIPTION OF THE DRAWINGS

The above and other exemplary aspects, features and advantages of certain exemplary embodiments of the present invention will become more apparent to a person or ordinary skill in the art from the following detailed description taken in conjunction with the accompanying drawings, in which:

FIG. 1 is a block diagram illustrating configuration of an electronic device for providing a lock function according to an exemplary embodiment of the present invention;

FIG. 2 is a flowchart illustrating exemplary operation of a process of defining an object used to release a lock function in an electronic device according to an exemplary embodiment of the present invention;

FIG. 3 is a flowchart illustrating exemplary operation of a process of releasing a lock function in an electronic device according to an exemplary embodiment of the present invention;

FIGS. 4A to 4C illustrate respective lock function release screens of an electronic device according to an exemplary embodiment of the present invention;

FIGS. 5A to 5C illustrate respective lock function release screens of an electronic device according to another exemplary embodiment of the present invention;

FIGS. 6A to 6C illustrate respective lock function release screens of an electronic device according to another exemplary embodiment of the present invention;

FIGS. 7A to 7D illustrate respective lock function release screens of an electronic device according to another exemplary embodiment of the present invention;

FIGS. 8A and 8B illustrate respective screens for defining an object for releasing a lock function in an electronic device according to an exemplary embodiment of the present invention;

FIGS. 9A to 9C illustrate respective screens for defining an object for releasing a lock function in an electronic device according to another exemplary embodiment of the present invention;

FIG. 10A is a flowchart illustrating exemplary operation of a process of releasing a lock function in an electronic device according to another exemplary embodiment of the present invention; and

FIG. 10B is a block diagram illustrating configuration of an apparatus for releasing a lock function in an electronic device according to another exemplary embodiment of the present invention.

### DETAILED DESCRIPTION

Exemplary embodiments of the present invention will be described herein below with reference to the accompanying drawings. In the following description, well-known functions or constructions may not be described in detail when their inclusion would obscure an artisan's appreciation of the invention with unnecessary detail about such well-known functions or constructions.

Hereinafter, a description will be given for an apparatus and method for releasing a lock function using a plurality of objects such as color information, coordinate information, and subject information in an electronic device. Herein, the electronic device uses a plurality of objects to prevent a pattern from being easily exposed by others. In addition, preferably, the electronic device may apply a concealment effect for at least one object specified by a user.

In addition, the electronic device can be a portable electronic device. The electronic device can be, for some non-limiting examples, any one of apparatuses such as a portable terminal, a mobile phone, a media player, a tablet computer, a handheld computer, and a Personal Digital Assistant (PDA). Also, the electronic device may be a certain portable electronic device including a device in which two or more functions are combined among these apparatuses.

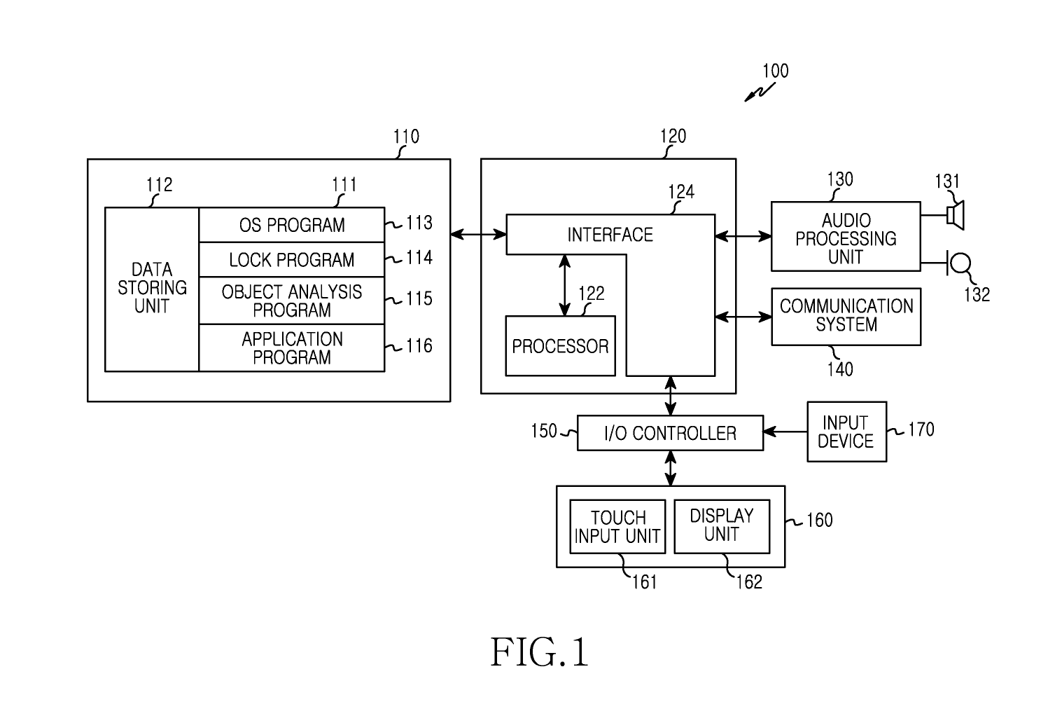

FIG. 1 is a block diagram illustrating exemplary configuration of an electronic device for providing a lock function according to one exemplary embodiment of the present invention.

As shown in FIG. 1, the electronic 100 in this example includes a memory 110, a processor unit 120, an audio processing unit 130, a communication system 140, an Input/Output (I/O) controller 150, a touch screen 160, and an input device 170. Herein, the memory 110 and the communication system 140 may be a plurality of memories and communication systems, respectively.

A description will be given for respective components as follows. The memory 110, which is a non-transitory machine readable medium, includes a program storing unit 111 for storing a program comprising machine executable code which controls an operation of the electronic device 100 and a data storing unit 112 for storing data items generated while the program is being executed. For example, the data storing unit 112 stores various rewritable data items such as phone books, outgoing messages, and incoming messages, and also stores information about a plurality of objects for performing or releasing a lock function and information about an input order of the objects.

Also, the program storing unit 111 includes an Operating System (OS) program 113, a lock program 114, an object analysis program 115, and at least one application program 116. Herein, the programs included in the program storing unit 111 may be expressed in a set of instructions. Also, the programs are expressed in an instruction set.

The OS program 113, for example includes several software components comprising machine executable code, that are executed by hardware such as a processor microprocessor for controlling an overall system operation. For example, control of this overall (i.e. general) system operation means memory management and control, storage hardware (device) control and management, power control and management, etc. This OS program 113 when loaded into and executed by hardware such as a processor performs a function for smoothly communicating between a plurality of hardware components (devices) and program components (modules).

The lock program 114 includes at least one or more software components comprising machine executable code for controlling a lock function. More particularly, if the input of a user is not sensed during a predetermined reference time or input of him or her for performing a lock function is sensed, the lock program 114 performs the lock function for preventing unnecessary generation of unnecessary touch input. On the other hand, if the input (previously defined object input, etc.) of an authorized user for releasing the lock function is sensed, the lock program 114 releases the lock function. Also, it is verified that when another person attempts to release the lock function, the lock program 114 changes an arrangement order of objects for releasing the lock function. When it is determined that another person attempts to release to the lock function may be based conditions where input of an unauthorized user is sensed by the number of predetermined times. Herein, the input of the authorized user for releasing the lock function is determined by the object analysis program 115, which is also loaded into hardware for execution.

The object analysis program 115 includes at least one or more software components comprising machine executable code for recognizing input of the user for controlling the lock function.

In other words, the object analysis program 115 may sense input of the user and verify an object selected thereby.

Herein, if the object selected by the user is identical to a previously defined object, the object analysis program 115 may determine that normal input for releasing the lock function is sensed.

Of course, the object analysis program 115 may verify an input order of objects and determine that normal input for releasing the lock function is sensed.

For example, it is assumed that the user defines an input order of an A object and a B object to release the lock function. If it is verified that the A object is selected by the user after the B object is selected thereby, because there is an error in the input order, the lock function is not released. Herein, the object may be any one of color information, location information, subject information of an image which is set to a lock screen, etc.

In addition, the object analysis program 115 when executed by hardware circuitry such as a processor or microprocessor, may analyze the image which is set to the lock screen and extract an object to be used to release the lock function.

For example, the object analysis program 115 when executed by hardware may analyze an output image, verify a subject, and provide information about the subject as an object to be used to release the lock function.

In addition, the object analysis program 115 when executed by hardware may analyze an output image, verify color information configuring the image, and provide color information of a threshold value or more as an object to be used to release the lock function.

The application program 116 includes a software component comprising machine executable code for at least one application program installed in the electronic device 100.

The processor unit 120 includes hardware such as at least one processor 122 and an interface circuitry 124. Herein, the processor 122, and the interface 124 may be integrated in at least one Integrated Circuit (IC) or be implemented as separate components.

The interface 124 functions as a memory interface for controlling the processor's 122 access to the memory 110.

In addition, the interface 124 functions as a peripheral interface for controlling connection between peripherals of the electronic device 100 and the processor 122 (see FIG. 1).

The processor 122 performs a control operation such that the electronic device 100 provides a lock function by executing at least one software program by the processor (or a microprocessor or sub-processor). Herein, the processor 122 performs a control operation such that the electronic device 100 executes by the processor at least one software program comprising machine executable code stored in the memory 110 and provides a lock function corresponding to the corresponding lock program. For example, the processor 122 may include a separate or dedicated lock processor for performing a lock function, an object analysis function, etc. In other words, in conjunction with hardware circuitry, the lock function of the electronic device can be performed by software in conjunction with hardware to execute the program stored in the memory 110 by the lock processor.

The audio processing unit 130 provides an audio interface between the user and the electronic device 100 through a speaker 131 and a microphone 132, and includes hardware such as a processor.

The communication system 140 performs a communication function for voice communication and data communication of the electronic device 100. Herein, the communication system 140 may be classified into a plurality of communication sub-modules that when executed will function to support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, a Near Field Communication (NFC) network, etc.

With continued reference to FIG. 1, the I/O controller 150 provides an interface between input and output devices, such as the touch screen 160 and the input device 170, and the interface 124.

The touch screen 160 comprises an I/O device that outputs information and receives input information and includes a touch input unit 161 and a display unit 162.

The touch input unit 161 provides touch information sensed through a touch panel to the processor unit 120 through the I/O controller 150. Herein, the touch input unit 161 changes touch information to a command structure such as touch down (touch), touch move (drag), and touchup (release), and provides the changed touch information to the processor unit 120 for execution.

With continued reference to FIG. 1, the display unit 162 displays status information of the electronic device 100, characters input by the user, moving pictures, still pictures, etc. For example, the display unit 162 can output visual information such as objects for controlling a lock function.

The input device 170 provides to the processor unit 120 through the I/O controller 150, an input data generated by selection of the user. For one example, the input device 170 includes only a control button for controlling the electronic device 100. For another example, the input device 170 can be equipped with a keypad for receiving an input data from the user.

Although not shown in FIG. 1, the electronic device 100 may further include components for providing additional functions, such as a camera module comprising a camera for photographing images or moving pictures, a broadcasting receiving module comprising a receiver for receiving broadcasting, a digital sound source reproduction module like an MP3 module, a local area wireless communication module for performing local area wireless communication, and a proximity sensor module for performing proximity sensing.

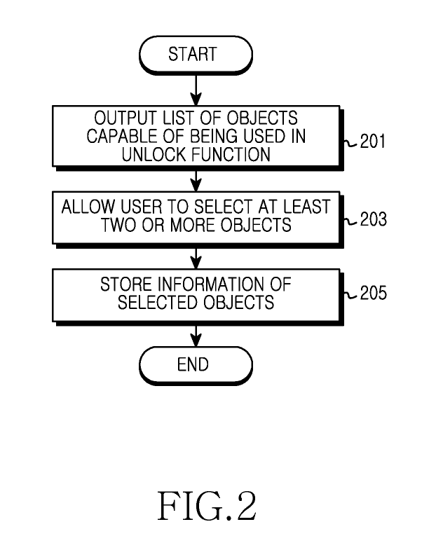

FIG. 2 is a flowchart illustrating an exemplary process of defining an object used to release a lock function in an electronic device according to one exemplary embodiment of the present invention.

Referring now to FIG. 2, at (S201) the electronic device outputs a list of objects capable of being used in a lock function (unlock function).

Herein, the list of the objects can include predetermined color information. In other words, a user may release the lock function using at least one color from color information. The color information may be previously defined as clearly classified colors by the user and may be stored in the electronic device. In addition, the color information can be acquired by analyzing an image which is set to a lock screen of the electronic device.

In addition, the list of the objects may include predetermined coordinate information. Herein, the coordinate information refers to a partial region of an output screen. The user may select the partial region on the output screen and release the lock function.

Herein, the electronic device can divide the output screen (output screen of the image which is set to the lock screen) into regions of a certain size and provide the divided regions to the user.

In addition, the electronic device can analyze the output screen, acquire a subject, and provide to the user a coordinate for the subject.

With continued reference to FIG. 2, at (S203) the electronic device the user to select at least two or more objects on the output object list.

At (S205) the electronic device stores information regarding the selected objects. In other words, the electronic device defines at least the two or more objects selected by the user that are to be used to release the lock function. When the objects selected by the user are sensed as being input, the electronic device releases the lock function that locks the electronic device. After defining the objects used to release the lock function, the electronic device ends the algorithm of FIG. 2.

In addition, although not shown in FIG. 2, when an input order of the objects selected by the user is defined, the electronic device may also store information about the input order. When the input order of the objects is defined, the user who wants to release the lock function must select objects in the order the objects are defined. Therefore, when the user inputs objects in an order in which has not been defined, the lock function will not be released and the electronic device will remain locked.

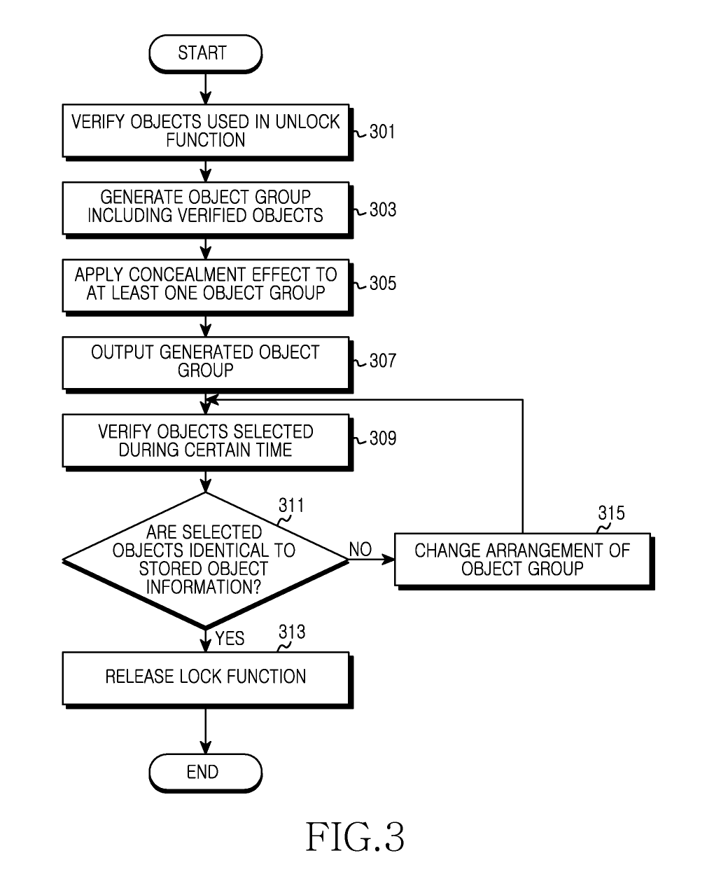

FIG. 3 is a flowchart illustrating exemplary operation of a process of releasing a lock function in an electronic device according to an exemplary embodiment of the present invention.

Referring now to FIG. 3, at (301), the electronic device verifies objects defined to be used to a lock function (unlock function).

Then, at (303), the electronic device generates an object group including the verified objects.

Herein, the generated object group includes a plurality of objects capable of being selected by a user and is generated per kind (type) of an object defined by him or her. Herein, the object defined by the user must be included in the object group.

For example, when the user defines an object for a blue color and an object for a left upper coordinate as objects for releasing a lock function, the electronic device generates an object group for the color and an object group for the coordinate. Herein, the object group for the color in this example must include the object of the blue color defined by the user amongst the different colors. In addition, the object group for the color may include objects (color information) of a black color, a white color, a green color, a red color, etc. Also, the object group for the coordinate must include the object indicating the left upper coordinate defined by the user.

In addition, the object group for the coordinate may include objects indicating a right upper coordinate, a left lower coordinate, a right lower coordinate, etc. In addition, it is unnecessary to follow a defined rule in arrangement of objects included in the object group. In other words, the arrangement of the objects may be changed whenever the object group is output.

It is desirable to include additional objects in the object group to the objects defined by the user in order to reduce probability that an unauthorized user can correctly select an object or objects for releasing the lock function by a random guess.

After generating the object group, the electronic device then performs step 305 and applies a concealment effect to at least one object group. The electronic device performs step 307 and outputs the generated object group.

With continued reference to FIG. 3, the electronic device then performs step 309 and verifies an object selected by the user during a certain time. The electronic device then performs step 311 and verifies whether the object selected by the user is identical to previously-stored object information.

If it is verified that the object selected by the user is not identical to the previously-stored object information, the electronic device performs step 315 and changes the arrangement of objects included in the output object group.

On the other hand, if it is verified that the object selected by the user is identical to the previously stored object information, the electronic device performs step 313 and releases a predetermined lock function.

In more detail, the electronic device releases the lock function only when input (object selection) of the user, corresponding to object information defined to release the lock function, is sensed. If it is determined that the input of the user is not identical to the defined object information, the electronic device rearranges objects of an object group and senses input of him or her.

In addition, when objects are input in an order in which they were not defined in advance, although the input corresponding to the defined object information is sensed, the electronic device does not release the lock function.

For example, when the user defines the object for the blue color and the object for the left upper coordinate as the objects for releasing the lock function, the electronic device generates object groups for the objects in a state where the lock function is set and outputs the generated object groups.

Accordingly, because the user who wants to release the lock function of the electronic device has memorized the previously-defined objects, the user selects the object for the blue color and the object for the left upper coordinate.

Sensing this selection of the user, the electronic device determines that the user has input the previously-defined objects accurately and releases the lock function.

The next case can include conditions where an input order for objects is not defined.

In a state where an input order is previously-defined in the order of (1) the object for the left upper coordinate and then (2) the object for the blue color, and the user selects (1) the object for the blue color and then selects (2) the object for the left upper coordinate. In this case, because the input order is not identical to the previously-defined input order although the previously-defined objects are accurately input, the electronic device determines that the user does not input the previously-defined objects accurately, holds a lock state, and changes and outputs a changed object arrangement of object groups. Therefore, there is an advantage in that the electronic device according to an exemplary embodiment of the present invention does not provide a fixed pattern like a conventional pattern password release method but always provides a pattern (object arrangement) of a new type by changing the arrangement of object groups, and thus strengthens security of the user.

Releasing the lock function according to the object selection of the user, the electronic device ends the algorithm of FIG. 3.

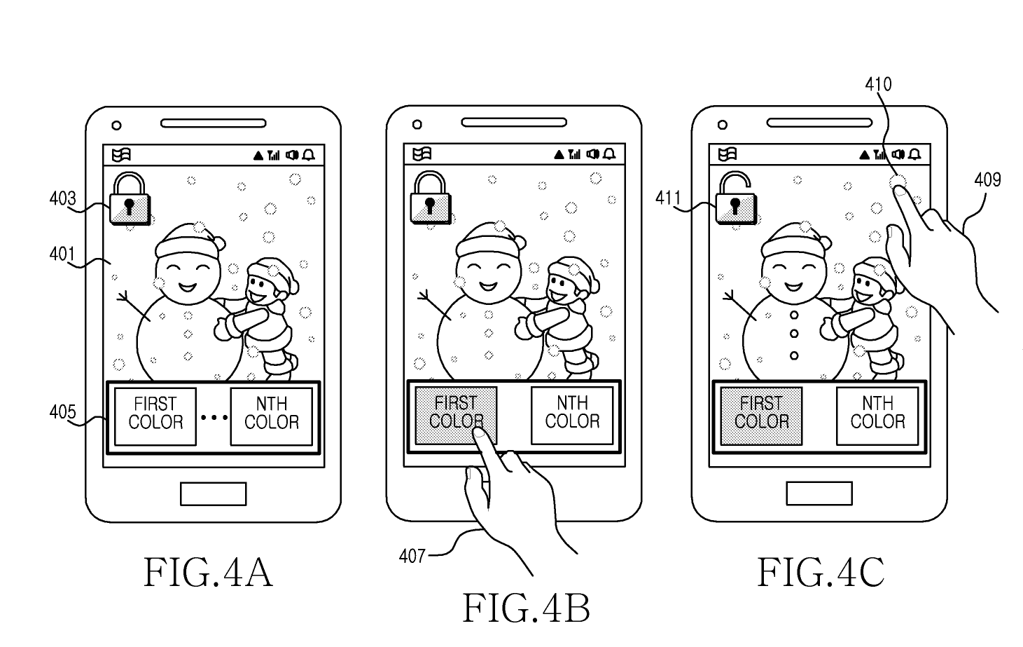

FIGS. 4A to 4C illustrate lock function release screens of an electronic device according to an exemplary embodiment of the present invention.

FIG. 4A illustrates a screen for performing a lock function in an electronic device according to an exemplary embodiment of the present invention.

First of all, as shown in FIG. 4A, the electronic device may inform a user that a current state is a state where a lock function is set by outputting a lock screen.

Herein, the lock function is used to prevent unnecessary touch input by the user who did not intend such input to be generated in an electronic device based on a touch screen and may include a touch lock mode.

Herein, as shown in FIG. 4A, the electronic device can output an object group 405 in a state 403 (a state where a lock screen 401 is output) where the lock function is set according to one exemplary embodiment of the present invention. Of course, this object group 405 may not be output until after input of the user is sensed. For example, after applying a concealment effect to the object group, when touch input on an output screen is sensed, the electronic device may output the object group. In other words, object group 405 might not be displayed until the screen is touch in a certain way, or a certain gesture is sensed, or a tap or wave, or possibly shaking the phone could cause the object group to be displayed.

Also, the object group 405 includes a plurality of objects. An object defined to release the lock function by the user must be included among the plurality of objects.

FIG. 4A illustrates a state where a first object group is output. The first object group includes objects for “n” color information. Of course, at least any one of the n color information is used to release the lock function. However, at least two or more objects must be used to release the lock function. In addition, the electronic device may change the arrangement for the “n” color information per certain time. In other words, when an object included in the object group is not selected during a certain time, the electronic device rearranges positions of objects and outputs the rearranged objects.

The result is that a plurality of objects are used to prevent objects for a lock function from being easily exposed to others. Of course, a plurality of objects for releasing the lock function may be included in the same object group, in another words, more than one object that releases the lock function can be provided. Also, the plurality of objects for releasing the lock function may be included in different object groups.

In addition, although it is not shown in FIG. 4A, there can be a second object group to which a concealment effect is applied on the screen 401 of the electronic device. For example, a lock screen output on the electronic device may be a second object group, and elements configuring the screen may be objects included in the second object group. More particularly, because the lock screen may include subjects, divided screens, feature points of subjects (e.g., a face), backgrounds, etc., at least any one of elements configuring the screen may be an object included in the second object group.

FIG. 4B illustrates a screen for allowing a user to select an object for releasing a lock function in an electronic device according to one exemplary embodiment of the present invention.

As shown in FIG. 4B, the electronic device outputs the first object group on the lock screen. The electronic device can apply a concealment effect to the second object group.

Accordingly, the electronic device verifies an object selected by the user in the first object group output on the lock screen. FIG. 4B illustrates user input 407 for selecting an object which is a first color information included in the first object group. However, the electronic device does not release the lock function with just the selected one object.

FIG. 4C illustrates a screen in which a lock function is released in an electronic device according to an exemplary embodiment of the present invention.

As shown in FIG. 4C, after the object of the first object group is selected, the electronic device senses user input 409 for selecting an object of the second object group. The object of the second object group may be coordinate information previously defined by the user.

As described above, the electronic device verifies at least two or more objects selected by the user and releases the lock function. Herein, FIG. 4C illustrates a state 411 where the lock function is released, as the padlock image is now in an unlocked state.

Also, FIG. 4C illustrates conditions where the user selects a specific position on the lock screen, which is defined as an object for releasing the lock function. The position selected by the user may be an object 410 included in the second object group.

FIG. 4C illustrates the second object group which is not output on a screen by applying a concealment effect to the second object group. However, when the concealment effect is not applied to the second object group, the electronic device may expose a certain position in addition to a position defined by the user on a screen. In FIG. 4C, the particular snowflake selected (in this case via touch at 409) was not concealed but actually can be said to be “hidden in plain sight” as selected from the second object group is a particular snowflake designated as the second object group. As the image shown in FIG. 4C is of a child making a snowman on a snowy day with lots of snowflakes shown, it would be particularly difficult for a unauthorized user to identify the second object group, even though it is clearly displayed.

In short, the electronic device may release the lock function only when the controller has verified that objects selected by the user are from among designated objects included in the first object group and the second object group are previously defined objects.

In addition, as described above, because the user may also define an input order of objects, the electronic device may release the lock function only when objects selected by him or her and the input order of the objects satisfy a previously-defined condition. Assuming that the user defines the input order of objects, he or she must input color information first and then input position information.

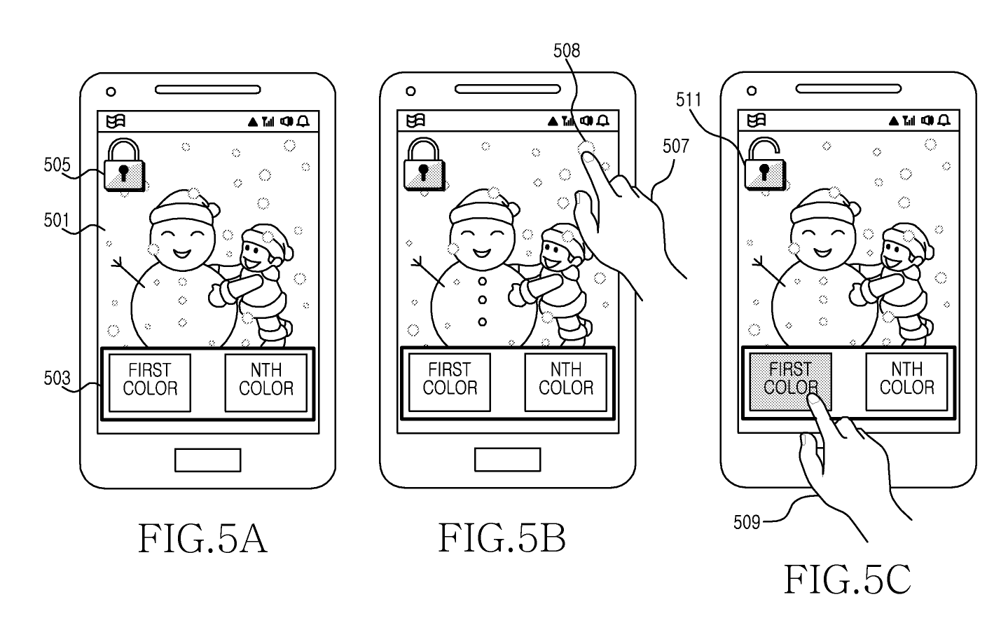

FIGS. 5A to 5C illustrate lock function release screens of an electronic device according to another exemplary embodiment of the present invention.

FIG. 5A illustrates a screen for performing a lock function in an electronic device according to another exemplary embodiment of the present invention.

As shown in FIG. 5A, the electronic device may inform a user that a current status of the electronic device is a state where a lock function is set by outputting display of a lock screen. Other images are possible to indicate the status, including but not limited to the words “Locked” and “Unlocked”.

Herein, the lock function is used to prevent unnecessary touch input from being generated that the user does not intend to be displayed in the electronic device based on a touch screen and may include a touch lock mode.

Herein, the electronic device may output an object group 503 in a state 505 (a state where a lock screen 501 is output) where a lock function is set according to another exemplary embodiment of the present invention. Of course, this object group 503 may be output after input of the user is sensed. For example, after applying a concealment effect to the object group, when touch input on an output screen is sensed, the electronic device may output the object group.

Also, the object group 503 includes a plurality of objects. An object that is defined to release the lock function by the user is to be included in the plurality of objects.

FIG. 5A illustrates a state where a first object group is output. The first object group includes objects for “n” color information. Of course, any one of the n color information can be used to release the lock function. However, at least two or more objects are used in this example to release the lock function. In addition, the electronic device may change arrangement for the n color information per certain time. In other words, when an object included in the object group is not selected during a certain time, the electronic device rearranges positions of objects and outputs the rearranged objects.

The result is that a plurality of objects are used to prevent objects for the lock function from being easily observed by unauthorized persons. Of course, a plurality of objects for releasing the lock function may be included in the same object group. Also, the plurality of objects for releasing the lock function may be included in different object groups.

In addition, although it is not shown in FIG. 5A, there may be a second object group to which a concealment effect is applied on a screen of the electronic device. For example, a lock screen output on the electronic device may comprise a second object group, and elements configuring the screen may also be objects included in the second object group. For this reason, the lock screen may include subjects, divided screens, feature points of subjects (e.g., a face), backgrounds, etc., at least any one of the elements configuring the screen may be an object included in the second object group.

FIG. 5B illustrates a screen for allowing a user to select an object for releasing a lock function in an electronic device according to another exemplary embodiment of the present invention.

As shown in FIG. 5B, the electronic device outputs the first object group on the lock screen. The electronic device applies a concealment effect to the second object group.

Accordingly, the electronic device verifies an object selected by the user in the first object group or the second object group output on the lock screen. FIG. 5B illustrates user input 507 for selecting an object (position) 508 included in the second object group. The 10 electronic device does not release the lock function with the selected one object.

FIG. 5C illustrates a screen in which a lock function is released in an electronic device according to another exemplary embodiment of the present invention.

As shown in FIG. 5C, after the object of the second object group is selected, the electronic device senses user input 509 for selecting an object of the first object group. Accordingly, as described above, the electronic device verifies at least two or more objects selected by the user and releases the lock function. Herein, FIG. SC illustrates a state 511 where the lock function is released.

Also, FIG. 5C illustrates conditions where the user selects color information defined as an object for releasing the lock function in the first object group. FIG. SC illustrates the second object group which is not output on a screen by applying a concealment effect to the second object group. However, when the concealment effect is not applied to the second object group, the electronic device may expose a certain position in addition to a position defined by the user on the screen.

In short, the electronic device in this example may release the lock function only after verifying that objects selected by the user among objects included in the first object group and the second object group are previously defined objects.

In addition, as described above, because the user may also define an input order of objects, the electronic device may release the lock function only when objects selected by him or her and the input order of the objects satisfy a previously-defined condition. Assuming that the user defines the input order of objects, he or she must input position information first and then input color information.

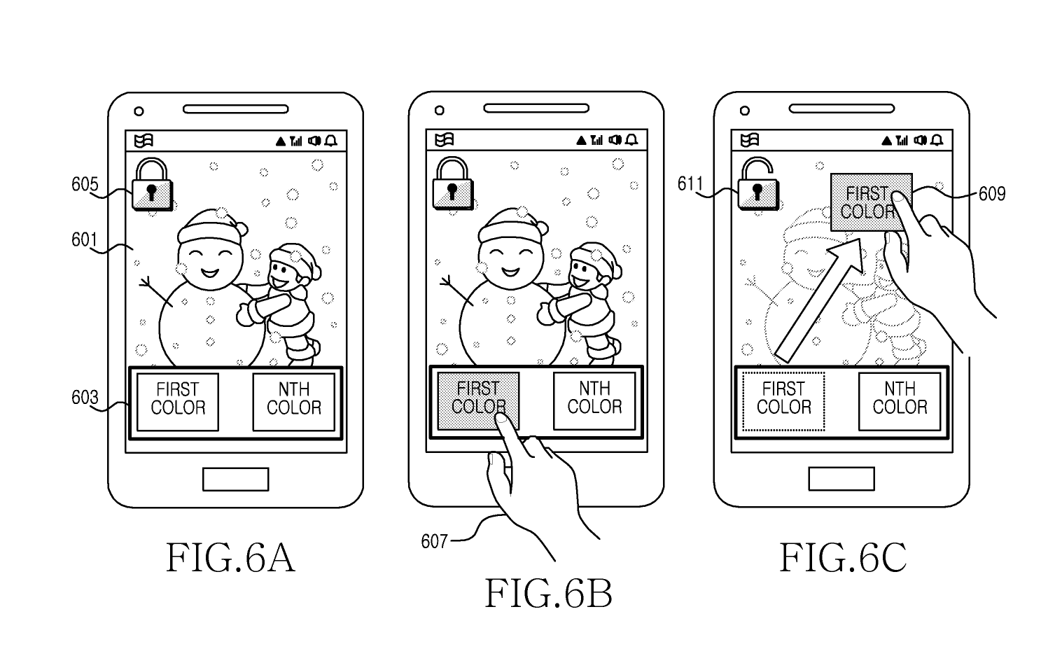

FIGS. 6A to 6C illustrate lock function release screens of an electronic device according to another exemplary embodiment of the present invention.

FIG. 6A illustrates a screen for performing a lock function in an electronic device according to another exemplary embodiment of the present invention.

First of all, as shown in FIG. 6A, the electronic device may inform a user that a current state is a state where a lock function is set by outputting a lock screen with a padlock 605 appearing to be locked.

Herein, the lock function prevents unnecessary touch input that the user did not intend to be generated in an electronic device based on a touch screen and may include a touch lock mode.

Herein, the electronic device may output an object group 603 in a state 605 (a state where a lock screen 601 is output) where a lock function is set according to another exemplary embodiment of the present invention. Of course, this object group 603 may be output after input of the user is sensed. For example, after applying a concealment effect to the object group, when a touch input on a screen is sensed, the electronic device may output the object group.

Also, the object group 603 includes a plurality of objects. An object defined to release the lock function by the user must be included in the plurality of objects.

FIG. 6A illustrates a state where a first object group is output. The first object group includes objects for n color information. Of course, any one of the “n” color information is used to release the lock function. However, at least two or more objects in this example are used to release the lock function. In addition, the electronic device may change the arrangement for the n color information per certain time. In other words, when an object included in the object group is not selected during a certain time, the electronic device rearranges the positions of objects and outputs the rearranged objects. The result is that a plurality of objects are used to prevent objects for the lock function from being easily observed by unauthorized users. Of course, a plurality of objects for releasing the lock function can be included in the same object group. Also, the plurality of objects for releasing the lock function may be included in different object groups.

In addition, although not shown in FIG. 6A, there may be a second object group to which a concealment effect is applied on a screen of the electronic device. For example, a lock screen output on the electronic device may be a second object group, and elements configuring the screen may be objects included in the second object group. That is, because the lock screen may include subjects, divided screens, feature points of subjects (e.g., a face), backgrounds, etc., at least any one of elements configuring the screen may be an object included in the second object group.

FIG. 6B illustrates a screen for allowing a user to select an object for releasing a lock function in an electronic device according to another exemplary embodiment of the present invention.

As shown in FIG. 6B, the electronic device outputs the first object group on the lock screen. The electronic device applies a concealment effect to the second object group.

Accordingly, the electronic device verifies an object selected by the user in the first object group output on the lock screen. FIG. 6B illustrates user input 607 for selecting an object which is a first color information included in the first object group. However, the electronic device does not release the lock function with the selected one object.

FIG. 6C illustrates a screen in which a lock function is released in an electronic device according to another exemplary embodiment of the present invention.

As shown in FIG. 6C, after the object of the first object group is selected, the electronic device verifies a position 609 to which the selected object is moved.

More particularly, the electronic device may verify an object which exists on a position 609 to which the object selected by the user is dragged and releases a lock function in this example only when it is verified that the two objects are previously-defined objects. Herein, FIG. 6C illustrates a state 611 where the lock function is released.

In addition, as described above, because the user may also define an input order of objects, the electronic device can release the lock function only when the objects selected by him or her and the input order of the objects satisfy a previously-defined condition.

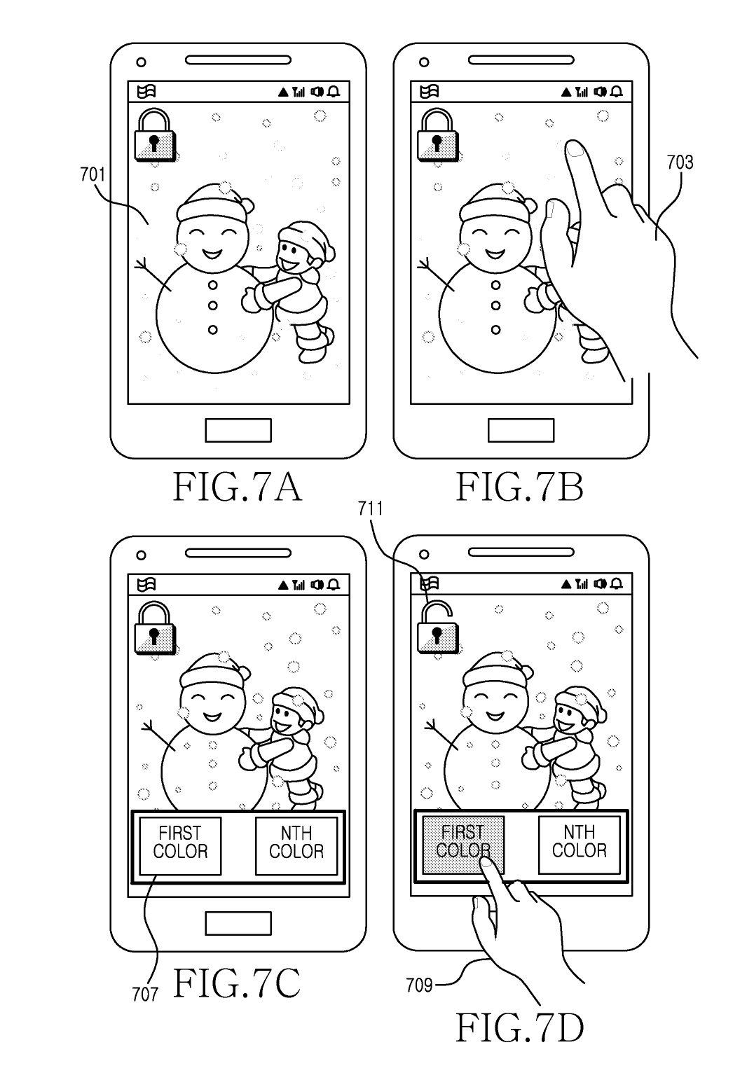

FIGS. 7A to 7D illustrate lock function release screens of an electronic device according to another exemplary embodiment of the present invention.

FIG. 7A illustrates a screen for performing a lock function in an electronic device according to another exemplary embodiment of the present invention.

First of all, as shown in FIG. 7A, the electronic device may inform a user that a current status of the electronic device is a state where a lock function is set by outputting a lock screen 701 that can have, for example, a padlock displayed that appears to be locked. In addition, the electronic device may inform the user that the current state is the state where the lock function is set by outputting an icon (e.g., a lock icon) for informing the user that the lock function is being performed in addition to the lock screen.

Herein, the lock function prevents from being generated unnecessary touch input that the user does not intend being displayed by the electronic device based on a touch screen and may include a touch lock mode.

As described above, the electronic device may output an object group in the state where the lock function is set according to exemplary embodiments of the present invention. However, the electronic device may apply a concealment effect to all object groups and output the object groups in a time point when input of the user is sensed.

FIG. 7B illustrates a screen for allowing a user to select an object for releasing a lock function in an electronic device according to another exemplary embodiment of the present invention.

As shown in FIG. 7B, the electronic device senses user input 703 for an object for releasing a lock function in conditions where an object group is not output. This means that an object group is not exposed on a screen because the user memorizes information (positions, colors, etc.) about objects. For this reason, an object group is prevented from being exposed by display to unauthorized users. If an object group is exposed by display to others, a malicious user will attempt to select an object for releasing a lock function by randomly selecting the object included in the object group. Of course, because the malicious user does not know the object for releasing the lock function, the malicious user does not select the object easily. However, the malicious user may select the object for releasing the lock function while repeating the above-described operation.

In order to prevent the above-described conditions from being generated, the electronic device according to another exemplary embodiment of the present invention applies a concealment effect to object groups.

FIG. 7C illustrates a screen for outputting an object group in an electronic device according to another exemplary embodiment of the present invention.

If the user input for the object for releasing the lock function is sensed, the electronic device outputs an object group. FIG. 7C illustrates conditions where the electronic device which senses object selection (object selection of FIG. 7B) by the user outputs an object group 707 including a plurality of color information.

Therefore, when user input for at least one object is sensed, the electronic device in which a plurality of objects are defined to release the lock function may output an object group including the other objects.

The result is that an operation for the user to select an object to output an object group is identical to an object selection process of releasing the lock function. In accordance with this operation, the electronic device may release the lock function quickly by omitting a process of selecting a first object. However, in accordance with this operation, the electronic device may lower security for selecting the first object.

Referring now to FIG. 7C, the electronic device in which color information and position information (object information) are defined analyzes an output lock screen. When a position where the user input is sensed is identical to previously defined position information (position information defined to release the lock function by the user), the electronic device outputs an object group including previously defined other information (color information). On the other hand, when the position where the user input is sensed is not identical to the previously defined position information, the electronic device then performs a process of outputting the lock screen in a state where the lock function is held.

FIG. 7D illustrates a screen for sensing user input for selecting a plurality of objects and releasing a lock function in an electronic device according to another exemplary embodiment of the present invention.

As shown in FIG. 7D, the electronic device senses user input for selecting at least one object and outputs an object group such that the user selects objects continuously.

In addition, as shown in FIG. 7D, if user input 709 for selecting an object for releasing the lock function is sensed, the electronic device compares the selected object with previously stored object information. The electronic device releases the lock function only when after successfully verifying that the object selected by the user is identical to the previously defined object. FIG. 7D illustrates a state 711 in which the lock function is released.

Also, FIG. 7D illustrates conditions where the lock function is released according as the user who selects the first object (position information) shown in FIG. 7B selects the second object (first color information).

In one exemplary embodiment of the present invention shown in FIGS. 7A to 7D, if user input for at least one object is sensed, the electronic device outputs the object group including the other objects.

In another exemplary embodiment of the present invention, the electronic device may output an object group including an object in which user input is sensed.

For example, the electronic device analyzes color information of an output lock screen and ascertains a color of a position where user input is sensed.

If the color of the position where the user input is sensed is identical to previously defined color information (color information defined to release the lock function by the user), the electronic device outputs an object group including the previously defined color information. If an object for the previously defined color information is input again, the electronic device outputs another object group in addition to color information and verifies whether a normal object is selected.

On the other hand, if the color of the position where the user input is sensed is not identical to the previously defined color information, the electronic device performs a process of outputting the lock screen in a state where the lock function is held.

Of course, the electronic device analyzes an output lock screen and ascertains a position where the user input is sensed. If the position where the user input is sensed is identical to previously-defined position information (position information defined to release the lock function by the user), the electronic device outputs an object group including the previously defined position information. If the object for the previously defined position information is again input, the electronic device outputs another object group in addition to the position information and verifies whether a normal object is selected.

If an operation for the user to select an object to output an object group is generated, the electronic device outputs an object group including the selected object and receives an object for releasing a lock function again. The electronic device may prevent a lock function from being released through this operation because an object is selected by an unauthorized person who attempts to input the object thoughtlessly or randomly.

In another exemplary embodiment of the present invention, the electronic device analyzes an output lock screen. If user input is sensed irrespective of previously defined object information, the electronic device may output an object group. Herein, the electronic device can output object groups for all if the objects. Alternatively, the electronic device can output one object group. If an object is normally selected, the electronic device may output a next object group.

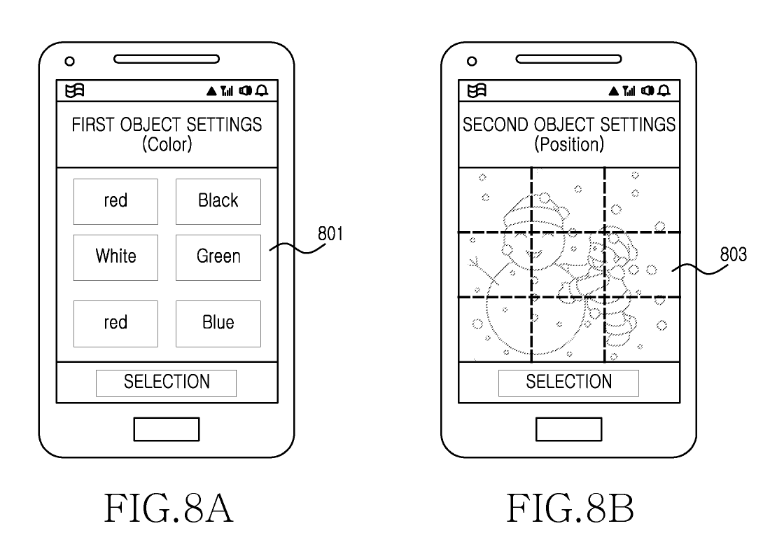

FIGS. 8A and 8B illustrate screens for defining an object for releasing a lock function in an electronic device according to one exemplary embodiment of the present invention.

First of all, although it is not shown in FIGS. 8A and 8B, the electronic device executes an application according to one exemplary embodiment of the present invention to select an object for releasing a lock function.

Herein, the application controls a lock function. The application may allow a user to select to a kind of an object for releasing the lock function. In addition, the application may allow or possible may require the user to select a minimum of two objects, and may increase the number of objects by adding different kinds of objects. Herein, the greater the increase in the number of objects, the greater is the number of objects which must be input to release the lock function. Accordingly, security for the lock function is enhanced as the ability to randomly select or casually observer a user and figure out the unlock sequence is far more difficult with a greater number of objects from which to choose.

FIG. 8A illustrates a screen for defining color information as a first object in an electronic device according to one exemplary embodiment of the present invention.

As shown in FIG. 8A, when it is verified that the user wants to use color information as an object, the electronic device may list color information capable of being used as objects and outputs the listed color information on a screen 801.

Herein, as shown in FIG. 8A, the electronic device may list predetermined color information and provide the listed color information. In other words, a storage device of the electronic device stores color information capable of being clearly classified by the user in advance. The user may only classify color information which is set per electronic device. There are various colors capable of being classified by the user. However, because it is not preferable that all color information is listed and stored in the electronic device, the electronic device classifies and stores only color information (e.g., red, orange, yellow, green, blue, etc.) which is frequently used by the user.

In addition, the electronic device may generate a list for color information in itself For example, the electronic device may analyze an image which is set to a lock screen and acquire color information of the image.

Herein, to acquire the color information of the image which is set to the lock screen is to provide an object capable of being selected on a screen output when a lock function is performed. It is therefore preferable that the electronic device lists color information including a certain amount of color information from among the color information of the image which is set to the lock screen. The reason for is because it is not preferable that the electronic device lists a plurality of colors because the plurality of colors are included in the image. This method is for providing more colors than previously defined color information. When the user selects color information for releasing the lock function in a state where the list with the plurality of color information is output, the electronic device stores the selected color information and outputs a screen capable of defining another object (a second object).

FIG. 8B illustrates a screen for defining position information as a second object in an electronic device according to one exemplary embodiment of the present invention.

As shown in FIG. 8B, when it is verified that the user wants to use position information as objects, the electronic device can list position information capable of being used as objects from an image which is set to a lock screen and output the listed position information on a screen.

Herein, the electronic device may divide the image which is set to the lock screen into regions 803 of a certain size and provide the divided regions to the user.

This particular case has an advantage in that a region which is not verified by not the user but by another person may be selected as an object because an object selection range may be the entire image. For example, because a background where there is no subject may be not exposed easily by others, the user may selects this region and enhance security. However, it is difficult for the user to memorize a selected region of the background.

In addition, the electronic device may analyze the image which is set to the lock screen, acquire a subject, and provide to the user a region for the subject. In this case there is a disadvantage in that an object selection range may be limited to objects. However, this case has an advantage in that the user may memorize a selected region easily.

For example, the user may define a person or some bodies such as eyes, a nose, a mouth, etc. of the person, which are included in an image, as an object.

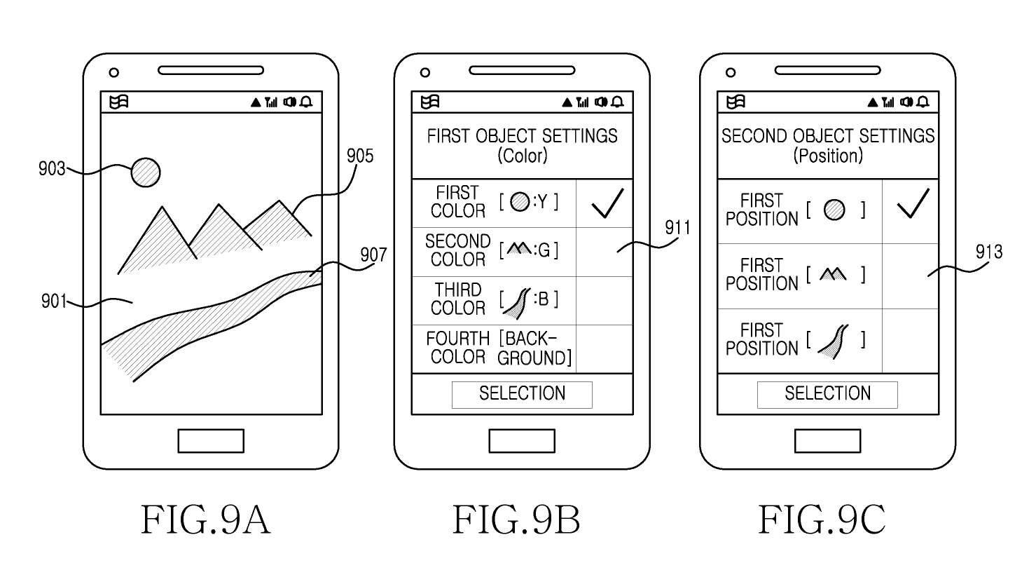

FIGS. 9A to 9C illustrate screens for defining an object for releasing a lock function in an electronic device according to another exemplary embodiment of the present invention.

First of all, although it is not shown in FIGS. 9A to 9C, the electronic device executes an application according to another exemplary embodiment of the present invention to select an object for releasing a lock function.

Herein, the application controls a lock function. In accordance with another exemplary embodiment of the present invention, the electronic device may analyze an image which is set to a lock screen and acquire an object capable of being used to release a lock function.

Accordingly, the user can select the object acquired by the electronic device (the application of the electronic device) and define the selected object as an object for releasing the lock function. The application can allow the user to select a minimum of two objects, and may increase the number of objects by adding more kinds of objects. Herein, the greater the number of objects, the greater the number of objects which can be input to release the lock function is increased. Accordingly, security for the lock function is enhanced.

FIG. 9A illustrates a screen for outputting an image which is set to a lock screen in an electronic device according to another exemplary embodiment of the present invention.

As shown in FIG. 9A, the electronic device can indicate that a lock function is set by outputting predetermined images.

Referring now to FIG. 9A, the image which is set to the lock screen includes four kinds of subjects. Herein, the subjects can refer to a thing, a person, a background, etc. included in the image. The image includes subjects such as the “sun 903”, the “mountain 905”, the “road 907”, and the “background 901”.

In accordance with another exemplary embodiment of the present invention, the electronic device may analyze the output image and extract an object capable of being used to release a lock function.

For example, the electronic device can extract subjects configuring the image and use the extracted subjects as an object capable of being used to release the lock function.

In addition, the electronic device may extract color information configuring the image and use the extracted color information as objects capable of being used to release the lock function.

FIG. 9B illustrates a screen for extracting color information from an image which is set to a lock screen.

Referring now to FIG. 9B, the electronic device may analyze an output image (the image which is set to the lock screen) and verify color information included in the image according to another exemplary embodiment of the present invention. For example, the electronic device may classify subjects on the output screen, list color information representing the subjects, and provide the listed color information on a screen 911.

In addition, the electronic device may verify color information by pixels of the output screen, list color information with much color distribution, and provide the listed color information.

The user may select color information for releasing the lock function from the output listed color information and store the selected color information.

FIG. 9B illustrates conditions where the electronic device outputs a list on which color information representing four kinds of objects is extracted from the output screen and the user selects a first color information corresponding to the “sun”.

The user may verify that the list of the color information output by the electronic device displays icons for subjects and color information representing the subjects together (e.g., the first color information is color information about the subject “sun” and an icon (“Y”) which means yellow is displayed.)

FIG. 9C illustrates a screen for extracting subject information from an image which is set to a lock screen in an electronic device according to another exemplary embodiment of the present invention.

Referring now to FIG. 9C, the electronic device can analyze an output image (the image which is set to the lock screen), verify subjects included in the image, list information about the subjects, and provide the listed information on a screen 913 according to another exemplary embodiment of the present invention.

The user can select a subject to be used to release the lock function from the output listed information and store the selected subject.

FIG. 9C illustrates conditions where the electronic device outputs a list for three subjects configuring the output image and the user selects a position of a subject corresponding to the “sun”.

The user may verify that the list of the subjects output by the electronic device displays an icon for a first position (e.g., it is displayed that the first position is information about the subject “sun”).

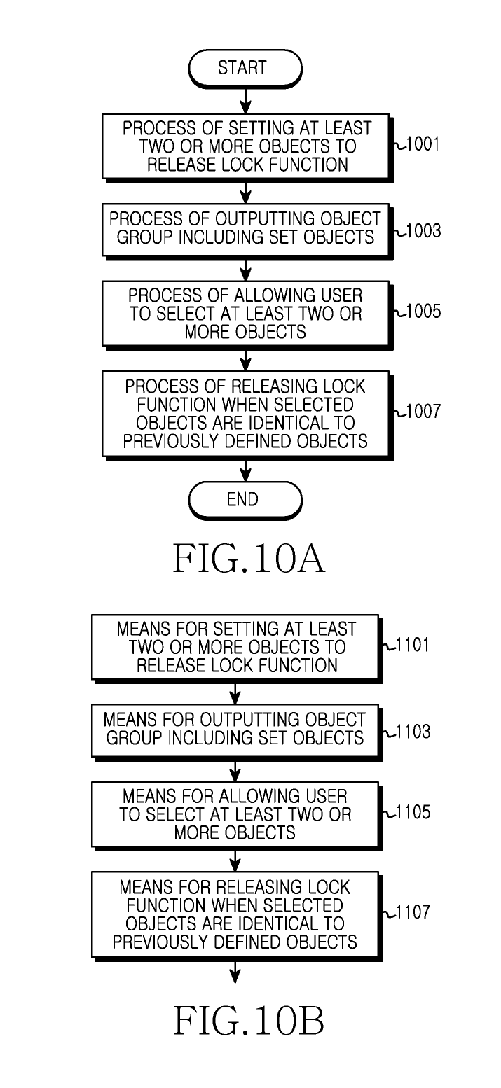

FIG. 10A is a flowchart illustrating a process of releasing a lock function in an electronic device according to another exemplary embodiment of the present invention.

Referring now to FIG. 10A, at (1001) the electronic device performs a process of identifying at least two or more objects that are set to release a lock function, at 1003 a process of outputting an object group including the set objects on a lock screen, at 1005 a process of allowing a user to select at least two or more objects on the lock screen, and at 1007 a process of releasing the lock function when the selected objects are identical to previously defined objects.

The process 1001 of setting at least the two or more objects to release the lock function means a process of defining the objects to release the lock function according to input of a user after the electronic device provides objects capable of being used to release the lock function to the user. Herein, as described above, the electronic device may output an object list defined therein. In addition, the electronic device may analyze the lock screen, extract objects capable of be used in the lock function, and output a list of the extracted objects. For one example, the electronic device may analyze an output image, verify subjects, and provide information about the subjects as objects to be used to release the lock function. For another example, the electronic device may analyze an output image, verify color information configuring the image, and provide color information of a threshold value or more as objects to be used to release the lock function.

In addition, the electronic device may define objects for releasing the lock function and an input order of the objects together.

The process 1003 of outputting the object group including the set objects on the lock screen and the process 1005 of allowing the user to select at least the two or more objects on the lock screen may be conditions whether the electronic device performs the lock function.

In other words, the electronic device may output objects defined by the user (objects used to release the lock function) on the lock screen.

Herein, the electronic device outputs an object group including the objects defined by the user and certain objects such that the user who wants to release the lock function selects objects. Herein, the more objects are included in the object group, the greater the probability that objects will be selected by others is lowered.

In addition, the electronic device may select an object group for each object and apply a concealment effect to the object group.

For example, the electronic device may generate a first object group and a second object group. The electronic device may output only the first object group, and apply a concealment effect to the second object group. The electronic device may output the second object group on a screen only when the user inputs objects for releasing the lock function normally in the first object group.

Also, if an object for releasing the lock function is incorrectly selected in an output object group, the electronic device determines that there may be conditions where the lock function is released by another person and changes arrangement of objects included in the object group.

When the selected objects are identical to previously-defined objects, the process 1007 of releasing the lock function means conditions where the same objects as objects defined in the process 1001 are input. Accordingly, the electronic device releases the lock function.

An instruction set for each process of FIG. 10A may be included in the lock program and the object analysis program of the memory 110 of FIG. 1. The programs may be executed by one or more processors.

FIG. 10B is a block diagram illustrating configuration of an apparatus for releasing a lock function in an electronic device according to another exemplary embodiment of the present invention.

First of all, the apparatus includes a means 1101 for setting at least two or more objects to release a lock function, a means 1103 for outputting an object group including the set objects on a lock screen, a means 1105 for allowing the user to select at least two or more objects on the lock screen, and a means 1107 for releasing the lock function when the selected objects are identical to previously defined objects.

The means 1001 for setting at least the two or more objects to release the lock function performs a process of defining the objects to release the lock function according to input of the user after the electronic device provides objects capable of being used to release the lock function to the user. Herein, as described above, the means 1101 may output an object list defined in the electronic device. In addition, the means 1101 may analyze the lock screen, extract objects capable of be used in the lock function, and output a list of the extracted objects. For one example, the means 1101 may analyze an output image, verify subjects, and provide information about the subjects as objects to be used to release the lock function. For another example, the means 1101 may analyze an output image, verify color information configuring the image, and provide color information of a threshold value or more as objects to be used to release the lock function.

In addition, the means 1101 may define an input order of the objects together in addition to the objects for releasing the lock function.

The means 1103 for outputting the object group including the set objects on the lock screen outputs objects (objects used to release the lock function) defined by the user on the lock screen.

Herein, the means 1103 outputs an object group including the objects defined by the user and certain objects such that the user who wants to release the lock function selects objects. Herein, the more certain many objects are included in the object group, the more probability that objects will be selected by others is lowered.

In addition, the means 1103 may select an object group for each object and apply a concealment effect to the object group.

For example, the means 1103 may generate a first object group and a second object group, and output only the first object group, and apply a concealment effect to the second object group. The means 1103 may output the second object group on a screen only when the user inputs objects for releasing the lock function normally in the first object group.

Also, if an object for releasing the lock function is incorrectly selected in an output object group, the means 1103 determines that there may be conditions where the lock function is released by another person and changes arrangement of objects included in the object group.

The means 1105 for allowing the user to select at least the two or more objects on the lock screen senses input of the user while the lock function is performed and verifies objects selected by him or her.

Also, when the selected objects are identical to previously defined objects, the means 1107 for releasing the lock function releases the lock function when the same objects as objects defined by the user are input in conditions where the lock function is performed.

These means may be configured as separate hardware or may be configured as an integrated hardware (integrated circuitry configured for operation) and would include a controller, or processor or microprocessor in the processing unit, for example, that controls the display of the touch screen, and to set the conditions for activating the lock function and includes identifying objects that can be set to permit a user to release the lock function, and such hardware can include at least some of the items shown in FIG. 1.

The electronic device for releasing the lock function using a plurality of objects and a method thereof according to exemplary embodiments of the present invention may improve a speed for releasing the lock function thereof and strengthen security of the user simultaneously.

The above-described apparatus and a method of operation according to the present invention can be implemented in hardware, and in part as firmware or via the execution of software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” comprises hardware in the claimed invention. Under the broadest reasonable interpretation, the appended claims constitute statutory subject matter in compliance with 35 U.S.C. §101.

The terms “unit” or “module” referred to herein is to be understood as comprising hardware such as a processor, microprocessor or other circuitry configured for a certain desired functionality, or a non-transitory medium comprising machine executable code, in accordance with statutory subject matter under 35 U.S.C. §101 and does not constitute software per se. While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of releasing a lock function using a plurality of objects in an electronic device, the method comprising:
identifying by a processor during a setting of the lock function at least two or more selected objects from the plurality of objects that are set for releasing the lock function;
outputting when the lock function is engaged on the electronic device an object group including the at least two or more selected objects set for releasing the lock function and an object group including additional certain objects from the output object groups accessible for selection;
determining by the processor that at least two or more objects from the output object groups accessible for selection have been selected for releasing the lock function; and
releasing the lock function when the processor determines the selected objects for releasing the lock function are identical to the two or more objects that were selected during the setting of the lock function.

2. The method of claim 1, further comprising verifying an input order of the selected objects for releasing the lock function is identical to an object input order when the lock function was set.

3. The method of claim 1, wherein the object groups are generated while being classified according to objects for releasing the lock function and wherein a concealment effect is applied to at least any one of the generated object groups.

4. The method of claim 1, wherein the setting of at least the two or more objects for releasing the lock function comprises:
outputting a list of the objects when the lock function is engaged that are selectable to release the lock function upon determining by the processor the selected objects are identical to the selected objected during the setting of the lock function; and
storing the objects selected and an object input order.

5. The method of claim 4, wherein the output of the list of the objects when the lock function is engaged comprises extracting the objects from an image which is set to the lock screen and are selectable to release the lock function upon determining the selected objects are identical to the selected objected during the setting of the lock function.

6. The method of claim 1, wherein the plurality of objects for releasing the lock function includes at least any one of color information, subject information, and position information.

7. The method of claim 1, further comprising outputting the object group when the lock function is engaged on the electronic device when an input is sensed in a state where the lock screen is output.

8. An apparatus for releasing a lock function using a plurality of objects, the apparatus comprising:
a display;
at least one processor;
a memory; and
at least one program comprising machine executable code which is stored in the memory and is configured to be executable by at least the one processor,
wherein the at least one processor is configured for identifying during a setting of the lock function at least two or more selected objects from a display of a plurality of objects that are set for releasing the lock function, controlling when the lock function is engaged on the apparatus an output by the display of an object group including the at least two or more selected objects set for releasing the lock function and an object group including additional certain objects from the output object groups accessible for selection, determining by the at least one processor that at least two or more objects from the output object groups accessible for selection have been selected for releasing the lock function; and
releasing the lock function when the at least one processor determines the selected objects for releasing the lock function are identical to the two or more objects that were selected during the setting of the lock function.

9. The apparatus of claim 8, wherein the at least one processor verifies whether an input order of the selected objects is identical to an input order of the two or more objects that were selected during the setting of the lock function.

10. The apparatus of claim 8, wherein the at least one processor generates the object groups while being classified according to objects for releasing the lock function and applies a concealment effect to at least any one of the generated object groups shown on the display when the lock function is engaged.

11. The apparatus of claim 8, wherein the at least one processor controls output of a list of the objects that are selectable to release the lock function upon determining the selected objects are identical to the selected objected during the setting of the lock function and storing the objects selected to release the lock function and an object input order.

12. The apparatus of claim 11, wherein the at least one processor extracts the objects that are selectable in the lock function from an image which is output by the lock screen.

13. The apparatus of claim 8, wherein the at least one processor analyzes at least any one of color information, subject information, and position information as the object for releasing the lock function.

14. The apparatus of claim 8, wherein the at least one processor outputs an object group when the lock function is engaged on the apparatus when an input is sensed in a state where the lock screen is output by the display.

15. A computer-readable medium storing one or more programs comprising machine executable code when executed by a processor of an electronic device to perform the method of claim 1.

16. A method in an electronic device, the method comprising:
displaying a first object group including first two or more objects and a second object group including second objects on a screen wherein the screen is under a lock state;
selecting at least two or more objects included in the output object groups; and
releasing the lock state of the screen when the selected objects are identical to previously defined objects.

17. The method of claim 16, wherein the releasing of the lock state is performed after verifying that a selection order of the selected objects is identical to a previously defined object selection order.

18. The method of claim 16, wherein the object groups are generated while being classified according to objects for releasing the lock state and wherein a concealment effect is applied to at least any one of the generated object groups.

19. The method of claim 16, wherein the setting of at least the two or more objects for releasing the lock state comprises:
outputting a list of the objects capable of being used to release the lock state; and
storing the objects selected by the user and an object input order.

20. The method of claim 19, wherein the output of the list of the objects capable of being used to release the lock state comprises extracting the objects capable of being used in the lock state from an image which is set to the lock screen.
